(19) United States
(12) Patent Application Publication
(10) Pub. No.: US 2025/0085960 A1
(43) Pub. Date: Mar. 13, 2025

(54) METHOD FOR UPDATING AN APPLICATION OF AN AUTOMOTIVE ELECTRONIC CONTROL UNIT

(71) Applicant: Robert Bosch GmbH, Stuttgart (DE)

(72) Inventors: Michael Pressler, Karlsruhe (DE); Andreas Burger, Weingarten (DE); Arne Hamann, Ludwigsburg (DE); Dakshina Narahari Dasari, Renningen (DE); Dirk Ziegenbein, Freiberg Am Neckar (DE); Emily Ruppel, Pittsburgh, PA (US)

(21) Appl. No.: 18/819,265

(22) Filed: Aug. 29, 2024

(30) Foreign Application Priority Data
Sep. 13, 2023 (DE) 10 2023 208 876.2

(51) Int. Cl. G06F 8/65; G06F 8/40

(52) U.S. Cl. CPC G06F 8/65; G06F 8/40

(57) ABSTRACT

A method for updating an application of an automotive electronic control unit. The method includes: converting the application of the automotive electronic control unit into a bytecode representation of the application; modifying the bytecode representation of the application at least with regard to at least one input and/or output interface thereof, the at least one input and/or output interface enabling a communication to at least one other application and/or to at least one other automotive electronic control unit; deploying the bytecode representation of the application on the automotive electronic control unit and/or on the at least one other automotive electronic control unit. A computer program, an apparatus, and a storage medium are also described.

### CROSS REFERENCE

The present application claims the benefit under 35 U.S.C. § 119 of German Patent Application No. DE 10 2023 208 876.2 filed on Sep. 13, 2023, which is expressly incorporated herein by reference in its entirety.

### FIELD

The present invention relates to a method for updating an application of an automotive electronic control unit. Furthermore, the present invention relates to a computer program, an apparatus, and a storage medium for this purpose.

### BACKGROUND INFORMATION

Modern vehicles comprise a multitude of different hardware and software components. It may often be the case that software components are specifically designed for an underlying hardware platform which may make the software components rather rigid. Making software components independent of the deployment and the underlying hardware platform is therefore particularly a long-term goal in the automotive domain, resulting, for example, in the standardization of the layered software architecture AUTOSAR. In AUTOSAR the concept of the virtual function bus (VFB) may provide infrastructure (e.g. hardware- and deployment) independency at design time. However, after compilation and deployment, the software components may be tied to their hardware platform and the communication between components may be hardcoded. In modern cars, where software may get updated more frequently and additional software may be installed during the lifecycle of a car, more flexible methods may be needed to change deployment on-the-fly or update functionality incrementally.

Thinking one step further, offloading computation to road-side infrastructure may require even more flexibility in the deployment of components. The adaption of existing, especially software written for classical AUTOSAR, to modern future-proof dynamic ecosystems may be challenging and not straight forward. The concept of clustering the software components in AUTOSAR particularly already tries to reduce the effort of recompiling and redeploying the updated code base. However, it may still require the recompilation of the whole software cluster including the basic software components (BSW) in the cluster.

Further, reprogramming a single software cluster may require re-booting the entire ECU because the behaviour of the cluster while it is reprogrammed may not be guaranteed. In short, existing solutions do particularly not support updates at runtime.

Existing classical AUTOSAR applications may, thus, be tied to a hardware platform and use standards interfaces that are fixed after compilation. Changes to the deployment, which also can include remapping of applications to other ECUs, may require complete recompilation and updating of the involved components and ECUs.

The software stack of AUTOSAR may heavily rely on the implementation language C. Writing applications in different programming languages like Rust and incrementally updating parts of the software may be challenging and time consuming.

### SUMMARY

According to aspects of the present invention a method, a computer program, a data processing apparatus, and a computer-readable storage medium are provided. Features and details of the present invention are disclosed herein. Features and details described in the context to the method of the present invention also correspond to the computer program of the present invention, the data processing apparatus of the present invention, and the computer-readable storage medium of the present invention, and vice versa in each case.

According to an aspect of the present invention a method for updating an application of an automotive electronic control unit is provided. According to an example embodiment of the present invention, the method comprises the following steps:
Converting the application of the automotive electronic control unit into a bytecode representation of the application,
Modifying the bytecode representation of the application at least with regard to at least one input and/or output interface thereof, the at least one input and/or output interface enabling a communication to at least one other application and/or to at least one other automotive electronic control unit,
Deploying the bytecode representation of the application on the automotive electronic control unit or on the at least one other automotive electronic control unit.

An application may in the context of the present invention be a software module that provides a functionality in a vehicle, for example an adaptive cruise control. The application may be a software module according to the standardized software framework AUTOSAR. The application may be provided on the automotive electronic control unit. The application may be executed on a runtime of the automotive electronic control unit. The converting of the application into the bytecode representation may be a compilation of the application, particularly to provide a WebAssembly bytecode. The modifying may also comprise providing at least one new functionality or modifying the existing functionality of the bytecode representation of the application. In an alternative, the bytecode representation is deployed on an edge computing device and/or a vehicle computer and/or a road-side computation node and/or a cloud service instead of the automotive electronic control unit and/or the at least one other automotive electronic control unit. The method may be advantageous to provide an update of the application without a need to update the automotive electronic control unit as a whole, so, for example, basic software components according to AUTOSAR do not have to be reinstalled. Furthermore, the application may advantageously become migratable in the bytecode representation thereof, since the bytecode representation may be agnostic regarding a respective hardware and/or operating system where the application is deployed.

According to an example embodiment of the present invention, it is possible that the method further comprises the following step:
Generating an access module, the access module providing the at least one input and/or output interface and a communication channel to enable the communication to the at least one other application and/or to the at least one other automotive electronic control unit by means of the at least one input and/or output interface and the communication channel.

The access module may advantageously enable a channel-based communication between applications, wherein said applications may be residing on the same runtime or on remote runtimes, for example on another automotive electronic control unit. Channels may abstract an underlying communication mechanism from the application logic to advantageously increase portability. The at least one input and/or output interface may be a WebAssembly System Interface (WASI), or in other words the WebAssembly System Interface may be used to provide the at least one input and/or output interface. WASI is particularly an application programming interface (API) designed to provide access to operating system interfaces.

In another example embodiment of the present invention, the method further comprises the following steps:
Executing the application and the bytecode representation of the application to provide an output of the application and an output of the bytecode representation of the application,
Validating the bytecode representation of the application based on a comparison of the output of the bytecode representation of the application with the output of the application, wherein the deploying is performed with the validated bytecode representation of the application.

The application and the bytecode representation of the application may be both executed on a runtime of the automotive electronic control unit. The validating may advantageously check if the bytecode representation of the application may provide the same functionality as the application by comparing the outputs. The validating may be performed by a validator component which may be generated during the converting as it may depend on the specific converted byte code representation. In an example, the performing of the deploying is dependent on a validation result of the validating. The validation result may be positive, if the output of the bytecode representation of the application and the output of the application are equal or only deviate within a defined threshold. The deploying may then only be performed, if the validation result is positive.

The bytecode representation of the application may also be executed on a runtime of a data processing unit that is separate from the automotive electronic control unit, particularly on a vehicle computer, a road-side computation node or a cloud service. This may be advantageous in that additional computing capacity may be provided by means of the separate data processing unit while also relieving computing demand off of the automotive electronic control unit that is necessary for the execution of the bytecode representation of the application.

According to an example embodiment of the present invention, it is possible that the method further comprises the following steps:
Defining a threshold for a deviation of the output of the bytecode representation of the application with respect to the output of the application,
Validating the bytecode representation of the application if the deviation of the output of the bytecode representation of the application with respect to the output of the application is lower than the defined threshold.

The threshold may advantageously be defined in accordance with specific requirements or an implementation of the automotive electronic control unit. If no threshold is defined, the output of the bytecode representation of the application and the output of the application may have to be equal for the bytecode representation of the application to be validated.

In another example embodiment of the present invention, the method further comprises the following step:
Initiating a feedback, preferably to a user, the feedback indicating a result of the validation.

The feedback to the user may be advantageous in that the user may react to the result accordingly, for example by initiating a countermeasure or by dismissing the bytecode representation of the application, at least temporarily. The feedback may be provided on a user interface.

According to an example embodiment of the present invention, the modifying of the bytecode representation of the application may further comprise the following step:
Modifying the bytecode representation of the application to provide an explicit communication, wherein data is exchanged via shared memory or global variables,
   an implicit communication, wherein data is buffered during an execution of the application and/or the bytecode representation of the application, and/or
   a timed communication, wherein data is transferred directly between the automotive electronic control unit and at least one other automotive electronic control unit.

The explicit, implicit and timed communication may be advantageous to provide that the bytecode representation of the application conforms to communication semantics defined by AUTOSAR.

In another aspect of the present invention, a computer program may be provided, in particular a computer program product, comprising instructions which, when the computer program is executed by a computer, cause the computer to carry out the method according to the present invention. Thus, the computer program according to the present invention can have the same advantages as have been described in detail with reference to a method according to the present invention.

In another aspect of the present invention, an apparatus for data processing may be provided, which is configured to execute the method according to the present invention. As the apparatus, for example, a computer can be provided which executes the computer program according to the present invention. The computer may include at least one processor that can be used to execute the computer program. Also, a non-volatile data memory may be provided in which the computer program may be stored and from which the computer program may be read by the processor for being carried out.

According to another aspect of the present invention a computer-readable storage medium may be provided which comprises the computer program according to the present invention and/or instructions which, when executed by a computer, cause the computer to carry out the steps of the method according to the present invention. The storage medium may be formed as a data storage device such as a hard disk and/or a non-volatile memory and/or a memory card and/or a solid state drive. The storage medium may, for example, be integrated into the computer.

Furthermore, the method according to the present invention may be implemented as a computer-implemented method.

Further advantages, features, and details of the present invention will be apparent from the following description, in which example embodiments of the present invention are described in detail with reference to the figures. In this context, the features mentioned herein may each be essential to the present invention individually or in any combination.

### BRIEF DESCRIPTION OF THE DRAWINGS

FIG. 1 shows a method, computer program, a storage medium, and apparatus according to example embodiments of the present invention.

FIG. 2 shows a schematic drawing of several automotive electronic control units according to example embodiments of the present invention.

### DETAILED DESCRIPTION OF EXAMPLE EMBODIMENTS

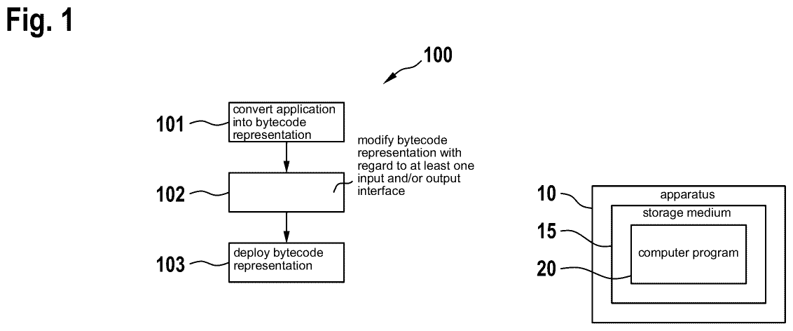

FIG. 1 shows a computer program 20, a storage medium 15 and an apparatus 10 according to example embodiments of the present invention.

FIG. 1 further shows a method 100 for updating an application 2 of an automotive electronic control unit 1 according to embodiments of the present invention. In a first step 101, the application 2 of the automotive electronic control unit 1 is converted into a bytecode representation of the application 3. In a second step 102, the bytecode representation of the application 3 is modified at least with regard to at least one input and/or output interface thereof. The at least one input and/or output interface may enable a communication to at least one other application 2′ and/or to at least one other automotive electronic control unit 1′. In a third step 103, the bytecode representation of the application 3 is deployed on the automotive electronic control unit 1 and/or on the at least one other automotive electronic control unit 1′.

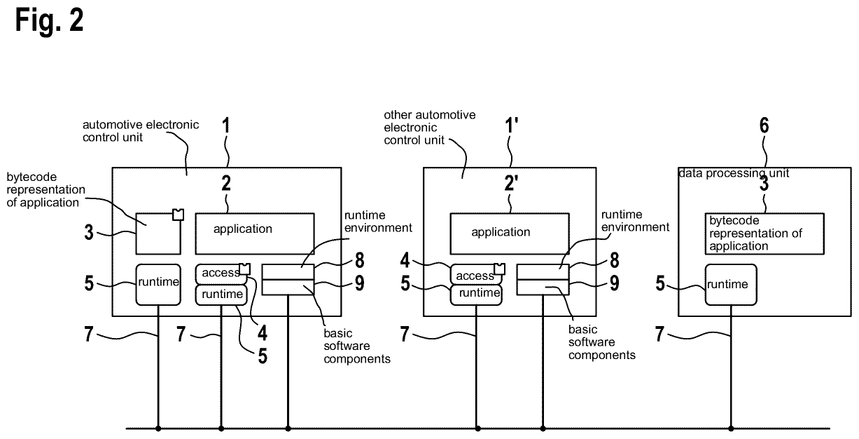

FIG. 2 shows a schematic drawing of automotive electronic control units 1 and a separate data processing unit 6 according to embodiments of the present invention. The automotive electronic control unit 1 on the left side comprises an application 2 with a runtime environment 8, basic software components 9, an access module 4, also referred to as IO (input output) module and a runtime 5. Further, the left automotive control unit 1 comprises a bytecode representation of the application 3 and a respective runtime 5 for executing the bytecode representation of the application 3. The communication of said runtimes may be transmitted via channels 7. The right automotive control unit 1′ only comprises an application 2′ with a runtime environment 8, basic software components 9, an access module 4, also referred to as IO (input output) module and a runtime 5. On the right, a separate data processing unit 6 is shown, which may be embodied as, for example, a vehicle computer, a road-side computation node or a cloud service. On the separate data processing unit 6, a bytecode representation of the application 3 is deployed which is executed on a runtime 5, which may communicate to the automotive electronic control units 1 via a channel 7.

A runtime environment 8 may also integrate parts of the basic software components 9 as a library in addition to WASI system interfaces (i.e. particularly the access module 4) and make these APIs available to WebAssembly modules (i.e. particularly to respective bytecode representations of applications 3). Thus, these WebAssembly modules may advantageously also address AUTSOSAR APIs via the runtime environment 8.

One aspect of the present invention may be a methodology to transform AUTOSAR software components, i.e., applications 2 of a respective automotive control unit 1, into virtualized components, i.e., bytecode representations of the applications 3, which can be flexibly deployed on ECUs within a car and, if needed also on separate data processing units 6, for example road-side computation nodes. One motivation may be that AUTOSAR software components may be, after compilation, tightly coupled to a particular hardware platform with a fixed deployment setup of all communication partners. This may limit flexibility in software updates and the deployment of additional software.

The following method according to example embodiments of the present invention may be embedded in a distributed edge computing ecosystem. This ecosystem may comprise automotive electronic control units 1 connected via network switches or regular ethernet.

Each of the automotive electronic control units 1 may have a runtime 5 installed which may provide a safe sandboxed isolated execution environment, particularly with inbuilt safety checks, which may also manage internal resource reservations for the electronic control units as well as providing an abstraction from the operating system and hardware. Additionally, a channel concept may be provided to decouple the communication between runtime 5 modules from the underlying realization. Besides, the runtime 5 may provide control over whether or not a module, i.e. particularly the bytecode representation of the application, is allowed to publish externally via an output suppression mode, which may enable the possibility of creating a passive hot-standby module which receives inputs, processes them but does not send out actuation commands. The runtime 5 itself may be capable to execute modules which are compiled as byte-code, e.g. WebAssembly, i.e. the bytecode representation of the application 3.

An Orchestrator (not shown) may be necessary for deploying and managing real-time execution modules on the different runtimes 5 according to the application requirements.

A validator component (not shown) may be used to compare outputs produced by an application 2 and a byte code representation of the application 2. This component may be generated during the converting as it may depend on the specific converted byte code representation.

An access module 4, which may also be referred to as IO module, may be generated during the transformation process in order to decouple an access of values from other electronic control units or from sensors and actuators from an underlying industrial field bus. The access module 4 may enable an accessibility of IO values on the runtime 5 communication.

A state transfer may be realized via a method call to a memory access API. The memory access API may bundle an internal memory state of the automotive electronic control unit 1 as a binary blob and then transfer it via tcp (client (Orchestrator)/server (electronic control unit)) by using Protocol Buffers or similar basic message passing/RPC implementations.

The following methodology according to an embodiment of the present invention may allow to migrate applications 2 to a reliable distributed (edge) computing ecosystem, which may provide benefits like flexibility, modularity and reliability. It may allow dynamically redeploying software, even to Commodity-Off-the-Shelf hardware without reimplementing the software component. It additionally may allow the incremental replacement and/or addition of software components written in modern programming languages in a hardware and OS agnostic way. The methodology may embed the transformed AUTOSAR application 3, i.e. the bytecode representation of the application 3, in a hardware and OS-agnostic runtime 5 execution module while still following the AUTOSAR communication semantics. Hence, the transformed and abstracted application 3 may be more flexible, easier to maintain and to modularize and/or to distribute over different edge compute nodes.

FIG. 2 provides an overview of the proposed methodology. To fully virtualize an AUTOSAR software component, i.e. an application 2 on an electronic control unit, the application 2 may be compiled to WebAssembly, i.e. to a byte code representation of the application 3, and executed using a runtime 5, preferably an RDS-enabled runtime 5, wherein RDS may stand for Reliable-Distributed System. For other legacy AUTOSAR components, an access module 4, or otherwise referred to as IO-Module, may be generated and the runtime 5 environment (RTE) communication calls from the software components may be replaced by a data exchange with the access module 4. The access module 4 may enable channel-based communication via channels 7 between modules, i.e. applications 2 or bytecode representations of applications 3, residing on the same or remote runtimes 5. Channels 7 may abstract the underlying communication mechanism from the application 2 logic to increase portability. OS-based calls from the applications 2 may be replaced by the WASI interface. WASI is an API designed to provide access to operating system interfaces.

In one scenario, the virtualization approach according to embodiments of the present invention may be used to move a legacy AUTOSAR component, i.e. an application 2, from a dedicated automotive electronic control unit 1 running on a real-time operating system to other computing nodes, i.e. separate data processing units 6, such as a vehicle computer with a POSIX-based operating system, a road-side computation node, or a cloud service, as long as the communication semantics specified by AUTOSAR are preserved after the redeployment. This virtualization approach may also allow for partial replacement of existing software with new implementations or algorithms, which can even be written in languages other than the original implementation language, such as Rust. Moreover, it may be possible to incorporate completely new software components into the system, which may not conform to the AUTOSAR standard, and enable data exchange with existing legacy code. Since the access module 4, or IO module, may be replacing parts of the run time environment 8 communication it may need to follow the execution semantics of AUTOSAR. This may include for example explicit, implicit, and timed communication.

An explicit communication particularly means that data is exchanged via shared memory/global variables. In this case, on every read from the AUTOSAR component, i.e. the application 2, the access module 4 may provide the latest available data point. A write to a variable may directly forward the data to the receivers of the Reliable-Distributed System-infrastructure.

In case of an implicit communication, input data of a component may be buffered during its execution. This particularly means that every access during one execution is reading the same data. In this case the access module 4 may need to buffer the data starting from the first access during one execution cycle until the module finishes one execution, which may be indicated via a specialized OS-call in classical AUTOSAR. The next read access may buffer the data again until the execution finishes. In case of write accesses, the data may be buffered until the execution is finished. After finishing one execution cycle all written variables may be published to subscribers of the written data points.

In case of a timed communication, also referred to as logical execution time (LET), the exchange of data is particularly shared not via global variables but directly between communication partners to ensure a deterministic data age. To provide an example, a data execution between a component, i.e. an application 2 or a bytecode representation of an application 3, executing in a period of 10 ms and another component executing in a 5 ms period. These components may exchange data deterministically every 10 ms just before the next release of each component. The logic of this communication scheme may be generated within the access module 4. In this example the component executing every 5 ms may only send data to the 10 ms component every second execution. Every data point may be buffered consumed. For example, even if the second execution of the 5 ms component finished its execution before the 10 ms component starts to execute, the new data may not be used until the synchronization point is reached.

The above explanation of the embodiments describes the present invention in the context of examples. Of course, individual features of the embodiments can be freely combined with each other, provided that this is technically reasonable, without leaving the scope of the present invention.

What is claimed is:

1. A method for updating an application of an automotive electronic control unit, the comprising the following steps:
converting the application of the automotive electronic control unit into a bytecode representation of the application;
modifying the bytecode representation of the application at least with regard to at least one input and/or output interface of the application, the at least one input and/or output interface enabling a communication to at least one other application and/or to at least one other automotive electronic control unit; and
deploying the bytecode representation of the application on the automotive electronic control unit and/or on the at least one other automotive electronic control unit.

2. The method of claim 1, further comprising the following step:
generating an access module, the access module providing the at least one input and/or output interface and a communication channel to enable the communication to the at least one other application and/or to the at least one other automotive electronic control unit using the at least one input and/or output interface and the communication channel.

3. The method of claim 1, further comprising the following steps:
executing the application and the bytecode representation of the application to provide an output of the application and an output of the bytecode representation of the application;
validating the bytecode representation of the application based on a comparison of the output of the bytecode representation of the application with the output of the application;
wherein the deploying is performed with the validated bytecode representation of the application.

4. The method of claim 3, wherein the bytecode representation of the application is executed on a runtime of a data processing unit that is separate from the automotive electronic control unit, the application being executed on a vehicle computer or a road-side computation node or a cloud service.

5. The method of claim 3, further comprising the following steps:
defining a threshold for a deviation of the output of the bytecode representation of the application with respect to the output of the application; and
validating the bytecode representation of the application when the deviation of the output of the bytecode representation of the application with respect to the output of the application is lower than the defined threshold.

6. The method of claim 3, wherein the method further comprises the following step:
initiating a feedback, the feedback indicating a result of the validation.

7. The method of claim 1, wherein the modifying of the bytecode representation of the application further comprises the following step:
modifying the bytecode representation of the application to provide: (i) an explicit communication in which data are exchanged via shared memory or global variables, and/or (ii) an implicit communication in which data are buffered during an execution of the application and/or the bytecode representation of the application, and/or (iii) a timed communication in which data are transferred directly between the automotive electronic control unit and at least one other automotive electronic control unit.

8. A data processing apparatus configured to update an application of an automotive electronic control unit, the data processing apparatus configured to:
convert the application of the automotive electronic control unit into a bytecode representation of the application;
modify the bytecode representation of the application at least with regard to at least one input and/or output interface of the application, the at least one input and/or output interface enabling a communication to at least one other application and/or to at least one other automotive electronic control unit; and
deploy the bytecode representation of the application on the automotive electronic control unit and/or on the at least one other automotive electronic control unit.

9. A non-transitory computer-readable storage medium on which are stored comprising instructions for updating an application of an automotive electronic control unit, the instructions, when executed by a computer, causing the computer to perform the following steps:
converting the application of the automotive electronic control unit into a bytecode representation of the application;
modifying the bytecode representation of the application at least with regard to at least one input and/or output interface of the application, the at least one input and/or output interface enabling a communication to at least one other application and/or to at least one other automotive electronic control unit; and
deploying the bytecode representation of the application on the automotive electronic control unit and/or on the at least one other automotive electronic control unit.
